(19) United States
(12) Patent Application Publication
(10) Pub. No.: US 2007/0138405 A1
(43) Pub. Date: Jun. 21, 2007

(54) Corona etching

(75) Inventors: James R. Shirck, Austin, TX (US); David D. Lu, Austin, TX (US); Seth M. Kirk, Minneapolis, MN (US); Gene B. Nesmith, Lago Visto, TX (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/303,399

(22) Filed: Dec. 16, 2005

(51) Int. Cl. H01J 27/00

(52) U.S. Cl. 250/426

(57) ABSTRACT

Provided is a method for removing organic residue from an electronic device substrate by exposure to a corona discharge.

### TECHNICAL FIELD

This invention relates to a corona etching organic material. In particular, the invention relates to corona etching for flexible circuit fabrication.

### BACKGROUND

Corona treatment of polymer film surfaces is well known.

One typical purpose of corona treatment, or “corona-priming,” of a polymer surface is to improve the interaction of the polymer surface with adhesives. Another purpose of corona treatment is to improve wettability of the surface. Corona priming of polymer films in air to increase interaction with adhesives and wettability of the surface is a well-known commercial process. Air corona priming is typically performed in the presence of ambient atmospheric gases (i.e., nitrogen and oxygen and trace gases) at atmospheric pressure.

### SUMMARY

An aspect of the present invention provides a method comprising: providing a substrate for an electronic device having an inorganic layer on which is a patterned layer of photoresist and organic residue on at least a portion of the inorganic layer exposed between the patterned photoresist; and removing the organic residue by exposing the substrate to a corona.

Another aspect of the present invention provides a method comprising: providing a substrate for a metallized circuit, the substrate having a conductive layer on its surface; forming a patterned layer of photoresist on the conductive layer by exposing the photoresist to actinic radiation through a mask and removing the undesired portion of the photoresist; subjecting the substrate with the patterned photoresist to a corona to remove any residue of the undesired portion of the photoresist.

The term “corona,” as used herein, refers to atmospheric-pressure dielectric barrier discharge, corona discharge, barrier discharge, atmospheric-pressure plasma, atmospheric-pressure glow discharge, atmospheric-pressure nonequilibrium plasma, silent discharge, atmospheric-pressure partially ionized gas, filamentary discharge, direct or remote atmospheric-pressure discharge, externally sustained or self-sustained atmospheric-pressure discharge, and the like and is to be distinguished from sub- atmospheric and vacuum-pressure electrical discharges or processes. However, the corona may occur in the gaseous atmosphere of specific compositions, i.e., in a controlled atmosphere.

An advantage of at least one embodiment of the present invention is improved trace adhesion in flexible circuits.

Another advantage of at least one embodiment of the present invention is a reduction in electrical shorts in flexible circuits.

Another advantage of at least one embodiment of the present invention is a reduction of small scale plating defects in flexible circuits.

Another advantage of at least one embodiment of the present invention is that corona processes are generally faster, cheaper, and more susceptible of application to in-line

Adustrial processes than are sub-atmospheric and vacuum-pressure processes.

Other features and advantages of the invention will be apparent from the following drawings, detailed description, and claims.

### BRIEF DESCRIPTION OF DRAWINGS

FIG. 1a is a scanning electron microscope (SEM) digital image of a fine pitch circuit made according to a prior art process.

FIG. 1b is an SEM digital image of a fine pitch circuit made according to an embodiment of the present invention.

FIG. 2 is an SEM digital image of photoresist remaining on a circuit-patterned substrate after resist stripping according to a prior art process.

FIG. 3a is an SEM digital image of a fine pitch circuit made according to an embodiment of the present invention.

FIG. 3b is an SEM digital image of a fine pitch circuit made according to an embodiment of the present invention.

FIGS. 4a and 4b are SEM digital images of a fine pitch circuit made according to an embodiment of the present invention.

### DETAILED DESCRIPTION

The present invention relates to the use of corona treatments to etch organic material from the surface of an inorganic substrate. This is particularly useful in the manufacture of electrical circuits such as flexible electronic circuits, semiconductor chips, and printed circuit boards. The demand for circuits having smaller circuit pitches is increasing as electronic designs move toward smaller features to meet the demands of lower cost and higher function and speed. Preferably the corona etching of the present invention is carried out at energy levels higher than those used for standard corona polymer surface modification.

Surprisingly and advantageously, the corona etching can be carried out on a substrate having a patterned photoresist layer on its surface without negatively affecting the patterned photoresist or its subsequent removal.

An aspect of the invention relates to a process enhancement for circuit fabrication, such as semi-additive circuit fabrication in which circuit features are electroplated within areas defined by patterned photoresist. The photoresist is typically laminated onto a uniform, thin “flash” layer of conductive material that has been coated onto a substrate. The conductive material is usually a metal such as copper. The photoresist is then patterned by exposure to actinic radiation, e.g., a light source, through a mask and is developed to remove the undesired portion of the photoresist to form the desired circuit trace pattern.

In a standard process, the next steps include electroplating a conductive material, typically a metal such as copper, on the exposed portion of the conductive flash layer, then removing the patterned photoresist. However, as can be seen in FIG. 2, some of the patterned photoresist remains on the flash layer as residue.

In addition, when the undesired portion of the photoresist is removed to form the desired trace pattern, residue from the photoresist may remain on the exposed portion of the flash layer between the patterned photoresist features, particularly along the edges of the photoresist pattern, where the photoresist abuts the exposed flash layer.

According to at least one aspect of the present invention, after the photoresist has been patterned and developed, the substrate is subjected to corona etching, which removes the organic residue remaining on the flash layer. Corona etching at this stage of circuit fabrication provides a number of benefits.

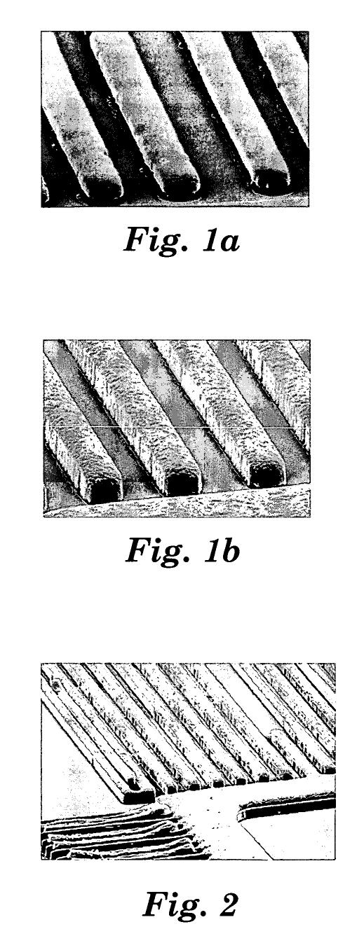

One benefit of corona etching is improved trace adhesion. For circuit fabrication processes such as a semi-additive process, reduction of circuit pitch makes it increasingly difficult to remove the film of residue that remains after photoresist is developed. The residue creates a defective interface between the flash layer and metal that is plated on the flash layer to form circuit traces. Residue remaining on the flash layer surface may interfere with the electroplating process and cause irregularities in plating thicknesses. Residue remaining along the edges of the photoresist pattern where it abuts the flash layer surface will impede conductive material from being electroplated at that location. When the patterned photoresist is subsequently removed and the then-exposed portion of the flash layer is removed by etching, the resulting circuit traces will have a recess, or “undercut,” along their bottom edges as is shown in FIG. 1a. This undercut reduces the attachment strength between the narrow traces and the substrate. In contrast, circuits plated after the corona etching of the present invention have less undercut as is shown in FIG. 1b and hence have improved trace adhesion.

Another benefit of corona etching is reduction of electrical shorts between the traces. Reduction of circuit pitch makes it more difficult to remove the patterned photoresist after circuit plating is completed. If photoresist is not removed, as is shown in FIG. 2, it will not be possible to remove the portion of the flash metal layer under the remaining photoresist, which is between adjacent traces. The result is an electrically defective (shorted) circuit. Undeveloped photoresist removal time can be decreased by at least 2× when the undeveloped photoresist is exposed to corona.

A further benefit of corona etching is reduction of small scale plating defects. Consistent electroplating requires the plating solutions to rapidly, uniformly wet the patterned substrate. As openings in the photoresist pattern become smaller, it becomes increasingly difficult for a plating solution to reach the flash metal surface. This results in small scale irregularities in plating thickness that are typically unacceptable. Flash layers and patterned resist that have been subjected to a corona etching treatment have better overall wetting characteristics than untreated flash layers and photoresist. Metal surfaces plated on the corona-treated flash layers are more uniform as a result. This may possibly be due to the corona etching causing the inorganic surface on the substrate to be temporarily hydrophilic.

At least one aspect of the invention includes exposing a substrate having a patterned photoresist on a flash layer to a corona. The corona may be generated by an alternating current. Preferably the corona is at a high frequency of about 1 to about 100 kHz, preferably about 10 to about 50 kHz. Suitable gases used to generate the corona include air, helium/oxygen mixtures, and other gas blends that contain at least one oxidizing gas. Air is most commonly used. As previously mentioned, the corona is typically carried out at or near atmospheric pressure. The corona is typically generated between a powered electrode and a grounded surface. The grounded surface may be a drun, i.e., a roll, a planar surface or another type of suitable surface.

Typically, the substrate to be subjected to the corona etching process will be in the form of a continuous multi-layered thin film, and may be in the form of a roll of film that may be fed continuously into a corona treatment apparatus. The substrate, however, be in any form, configuration, or thickness and may be treated in batch mode.

Typically, the substrate is placed in, or passed through, the electrode/ground-roll gap. A suitable gap size is a nominally 60 mil gap. The substrate may be passed through the gap at any suitable speed. A typical speed is about ½ to about 1 meter/minute. The substrate may be passed through the gap multiple times. One to ten passes are typical, depending on the desired total energy delivered. In a suitable system, the area of the substrate within the corona is about 4 cm in the down-web direction by about 30 cm in the cross-web direction. The corona discharge area will vary depending on the system used.

The substrate is typically exposed to the corona for 1 to 5 seconds. This is in contrast to typical corona surface treatments which have exposure times of fractions of seconds. This long treatment time results in a significant quantity of organic residue on the surface of the flash layer being etched away. As can be seen in FIG. 2, if the residue is from the photoresist, it can be as thick as the photoresist layer, which was 20 microns thick.

The corona etching may be performed in any typical corona treatment system so long as the system provides adequate power to enable etching. Corona treaters adaptable for use in the present invention are commercially available, for example from Sherman Treaters, Ltd. (Thame, UK), Enercon Indus. Corp. (Menomonee Falls, Wis.), and Pillar Technologies (Hartland, Wis.). For the present invention, the corona treater is typically operated at about 5,000 to about 10,000 volts. Typical power levels are from about 0.5 to about 1.0 kilowatts.

The corona etching utilized in the present invention may be characterized by a calculated value of “normalized energy” Normalized energy has units of Joules per centimeter squared (J/cm²) and is calculated from the net power supplied to the electrode P (in watts), the electrode width w (in cm) and the film velocity s (in cm/sec), according to the following formula:
normalized energy=P/ws

In at least one preferred embodiment of the present invention, the corona discharge is characterized by having a normalized energy of between about 10 and about 200 J/cm², and more preferably between about 75 and about 150 J/cm².

A typical sequence for making a flexible circuit using a process that includes corona etching is as follows:

A substrate is first made or obtained consisting of a polymeric film layer of from about 25 micrometers to about 125 micrometers having a copper layer of about 1 to about 5 micrometers thick. The substrate may be made by various methods such as adhesively bonding a polyimide layer onto copper foil, coating liquid polyimide on copper foil or the like.

A UV-curable photoresist, such as those available under the trade designations SUNFORT SPG-102 and SPG-202 from Asahi Chemical Industry Co., Tokyo, Japan, or a dry film resist of similar type, is laminated onto both sides of a substrate having a polymeric film side and a copper side, using a laminator, such as one available under the trade designation model number XRL-120A from Western Magnum, El Segundo, Calif., at 235° F.

The photoresist is then exposed on both sides to ultraviolet light or the like, through a mask, thereby crosslinking the exposed portions of the photoresist. The unexposed photoresist is then developed (removed) using a mild alkaline solution such as a solution of about 0.75% to about 1% sodium to form the desired photoresist pattern. The substrate with the patterned photoresist is then treated in a corona discharge before the exposed copper is further plated to a desired thickness. After the copper plating is completed, the crosslinked photoresist is removed in a solution of about 2 to about 5% alkaline metal hydroxide at from about 20° C. to about 80° C., preferably from about 20° C. to about 60° C. at 4 to 5% alkaline metal hydroxide solution. The resist removal time was recorded in second.

Subsequently, the original thin copper layer is etched with an etchant such as that available under the trade designation PERMA-ETCH, from Electrochemicals, Inc., Maple Plain, Minn. The isolated copper traces may then be examined under scanning electron microscope (SEM) to measured the degree of undercut occurring during the etching process. The undercut is primary caused by a thin layer of photoresist residue between the thin flash copper layer and the plated copper layer.

### EXAMPLES

This invention is illustrated by the following examples, but the particular materials and amounts thereof recited in these examples, as well as other conditions and details should not be construed to unduly limit this invention.

### Examples 1 and 2 and Comparative Example C1

To make Example C1, a 3.2 um copper layer was flash electroplated on a 50 um thick polyimide film. A dry film photoresist, available under the trade designation SUNFORT SPG-102 from Asahi Chemical Industry Co., Japan, was then laminated to both sides of the polymeric and copper side of the substrate at 235° F., using laminator available as trade designation model number XRL-120A from Western Magnum, El Segundo, Calif. The photoresist was then exposed on both sides to ultraviolet light through a mask, which crosslinks the exposed portions of the photoresist. The unexposed photoresist was then developed using a mild alkaline 0.75% sodium carbonate solution to form the desired pattern.

Examples 1 and 2 were made in a manner similar to Example C1 but were treated in a corona discharge in an air atmosphere using a corona treater station available under the trade designation model number LM4453-01 from Enercon Industries Corporation, Menomonee Falls, Wis. In this station, samples are transported on a cooled, ceramic-coated ground roll, and air, or other process gas is introduced between pairs of ceramic covered electrodes, each 30 cm in length, in two different electrode assemblies. The face of the powered electrodes and the face of the ground roll are separated by a nominal 60 mil gap.

In Example 1, 1.0 kilowatt was delivered to the electrodes, and the circuit sample was transported through the discharge that developed between the electrode and the ground roll at 1.7 cm/sec. This treatment by exposure to the corona was repeated five times to deliver a total treatment of 98 J/cm²

In Example 2, 1.0 kilowatt was delivered to the electrodes, and the circuit sample was transported through the discharge that developed between the electrode and the ground roll at 1.7 cm/sec. This treatment by exposure to the corona was repeated two times to deliver a total treatment of 39 J/cm²

Each of Comparative Example C1, and Examples 1 and 2 were then plated in a copper solution to achieve the desired circuit thickness. Upon completion of copper plating, resist was then stripped by conventional alkaline solution (about 4-5% KOH, at about 60-65° C.). The resist removal time was recorded in second. The exposed portion of the thin flash copper layer was then removal by etching solution of 10 parts water, 1 part sulfuric acid, 1 part of 30% H₂ 0₂ to produce electrically isolated traces.

The comparison of resist stripping times for Examples C1 (untreated) and Example 1 (treated) are shown in Table 1.

TABLE 1

| Example | Resist stripping time (sec) |
|---|---|
| 1 | 7 |
| C1 | 19 |

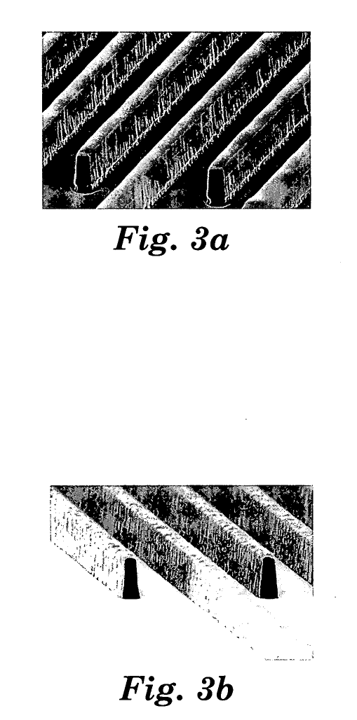

Examples 1 and 2 were also examined under a scanning electron microscope (SEM) to measure the degree of undercut during the etching process. The effect of corona treatment energy on undercut is shown in FIG. 3a and FIG. 3b. The substrate in FIG. 3a was treated as described in Example 2 and the substrate in FIG. 3b was treated as described in Example 1.

### Example 3

Example 3 was made in a manner similar to Example 1, except that the gas mixture delivered between the sets of electrodes was 17% oxygen in helium. 0.5 kW was delivered to the electrodes and the sample was passed through the discharge ten times at 1.7 cm/sec to deliver a total treatment of 98 J/cm2.

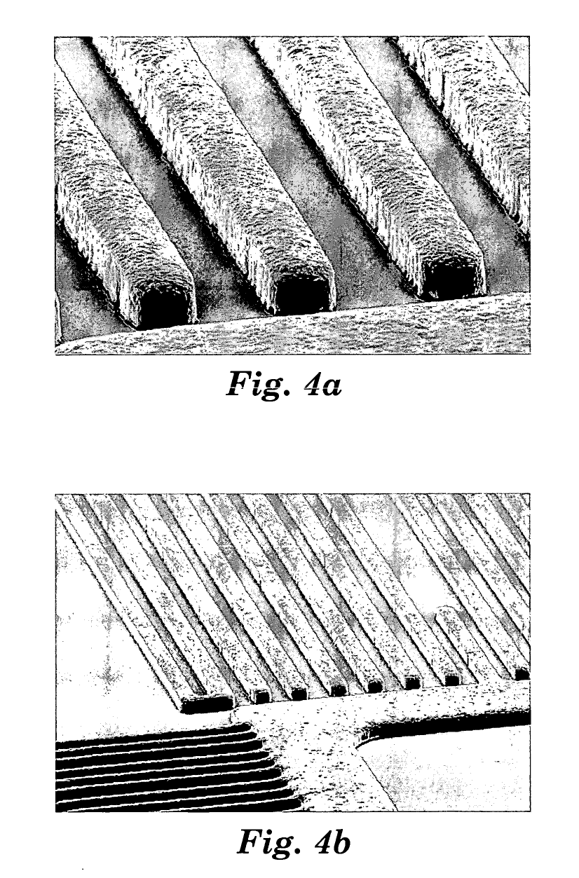

The resulting circuit was examined under an (SEM) to measure the degree of undercut during the etching process. Example 3 had negligible undercut as shown in FIGS. 4a and 4b.

Various modifications and alterations of this invention will become apparent to those skilled in the art without departing from the scope and spirit of this invention and it should be understood that this invention is not to be unduly limited to the illustrative embodiments set forth herein.

What is claimed is:

1. A method comprising:
Providing a substrate for an electronic device having an inorganic layer on which is a patterned layer of photoresist and organic residue on at least a portion of the inorganic layer exposed between the patterned photoresist; and
removing the organic residue by exposing the substrate to a corona.

2. The method of claim 2 wherein the organic residue is a photoresist material.

3. The method of claim 1 wherein the inorganic layer is selected from the group consisting of metals, metal oxides, and alloys thereof.

4. The method of claim 1 wherein the electronic device comprises a flexible circuit.

5. The method of claim 1 wherein the electronic device comprises a printed circuit board.

6. The method of claim 1 further comprising depositing a layer of conductive material on the portion of the inorganic layer exposed between the patterned photoresist.

7. The method of claim 6 further comprising removing the patterned photoresist.

8. The method of claim 1 wherein the organic residue is exposed to the corona at a normalized energy of about 10 to about 200 J/cm2.

9. The method of claim 1 wherein the organic residue is exposed to the corona at a normalized energy of about 75 to about 150 J/cm2.

10. The method of claim 1 wherein the substrate is transported past the corona source on a reel-to-reel system.

11. The method of claim 1 wherein the frequency of the corona is in the range of about 1 to 100 kHz.

12. A method comprising:
Providing a substrate for a metallized circuit, the substrate having a conductive layer on its surface;
Forming a patterned layer of photoresist on the conductive layer by exposing the photoresist to actinic radiation through a mask and removing the undesired portion of the photoresist;
Subjecting the substrate with the patterned photoresist to a corona to remove any residue of the undesired portion of the photoresist.

13. The method of claim 12 further comprising electroplating a conductive material onto the exposed portions of the conductive layer.

14. The method of claim 12 further comprising removing the patterned photoresist.

15. The method of claim 12 wherein the conductive layer is selected from the group consisting of metals, metal oxides, and alloys thereof.

16. The method of claim 12 wherein the organic residue is exposed to the corona for at least one second.

17. The method of claim 12 wherein the substrate is transported past the corona source on a reel-to-reel system.

18. The method of claim 12 wherein the organic residue is exposed to the corona at a normalized energy of about 10 to about 200 J/cm2.

19. The method of claim 12 wherein the organic residue is exposed to the corona at a normalized energy of about 75 to about 150 J/cm2.

20. The method of claim 12 wherein the frequency of the corona is in the range of about 1 to about 100 kHz.
